(19) United States
(12) Patent Application Publication
(10) Pub. No.: US 2025/0304043 A1
(43) Pub. Date: Oct. 2, 2025

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventors: Fumiya Kobayashi, Tokyo (JP); Kentaro Fukuda, Tokyo (JP); Shuhei Kawamura, Tokyo (JP)

(21) Appl. No.: 19/056,810

(22) Filed: Feb. 19, 2025

(30) Foreign Application Priority Data
Mar. 29, 2024 (JP) 2024-055666

(51) Int. Cl. B60W 30/09; B60W 30/095; B60W 30/14; G06V 20/56; G06V 20/58

(52) U.S. Cl. CPC B60W 30/09; B60W 30/0956; B60W 30/146; G06V 20/58; G06V 20/588; B60W 2420/403; B60W 2420/408; B60W 2552/30

(57) ABSTRACT

Provided is a driving assistance device including: a storage medium which has computer-readable instructions stored therein, and a processor which is connected to the storage medium, in which the processor is constituted to execute the computer-readable instructions to: recognize a road division line of a traffic lane in which the vehicle is traveling and an obstacle which exists around the vehicle using at least one of a camera and a radar installed in a vehicle, determine whether the road division line indicates a curved road on the basis of a length of the recognized road division line, and perform a driving assistance for the vehicle in accordance with the recognized obstacle, and the processor performs correction so that a determination region that is a range in which the obstacle is recognized for the driving assistance is narrowed when it is determined that the road division line indicates a curved road.

### CROSS-REFERENCE TO RELATED APPLICATION

Priority is claimed on Japanese Patent Application No. 2024-055666, filed Mar. 29, 2024, the content of which is incorporated herein by reference.

### BACKGROUND

### Field of the Invention

The present invention relates to a driving assistance device, a driving assistance method, and a storage medium.

### Description of Related Art

In recent years, efforts to provide access to considerate and accessible transport systems to participants in vulnerable situations among transport participants have intensified. In order to realize the efforts, research and development to further improve transportation safety and convenience through research and development associated with prevention and safety techniques has been focused upon.

Incidentally, in the prevention and safety technique, the task is to detect a predetermined section such as a curved road of a traffic lane in which a vehicle is traveling and to perform or suppress a driving assistance such as a decrease in speed according to the detected predetermined section. For example, Japanese Unexamined Patent Application, First Publication No. 2015-197794 describes a technique of estimating whether a traffic lane in which a subject vehicle is traveling is a curved road based on changes in curvature of division lines which make up the traffic lane. Japanese Unexamined Patent Application, First Publication No. 2016-081202 describes a technique in which an object detected using a radar and an object detected using a camera match and a driving assistance is performed or suppressed in accordance with the matching result.

Here, in the technique in the related art, it is sometimes impossible to detect the presence of a curved road in the distance and to appropriately suppress a driving assistance in accordance with the detected curved road.

### SUMMARY

The present invention was made in consideration of these circumstances, and an object of the present invention is to provide a driving assistance device, a driving assistance method, and a storage medium which are capable of detecting the presence of a curved road which exists in the distance and appropriately suppressing a driving assistance in accordance with the detected curved road. In addition, the present invention contributes to the development of an accessible transport system.

A driving assistance device, a driving assistance method, and a storage medium according to the present invention adopt the following constitution.

(1): A driving assistance device according to an aspect of the present invention includes: a storage medium which has computer-readable instructions stored therein, and a processor which is connected to the storage medium, in which the processor is constituted to execute the computer-readable instructions to: recognize a road division line of a traffic lane in which the vehicle is traveling and an obstacle which exists around the vehicle using at least one of a camera and a radar installed in a vehicle, determine whether the road division line indicates a curved road on the basis of a length of the recognized road division line, and perform a driving assistance for the vehicle in accordance with the recognized obstacle, and the processor performs correction so that a determination region that is a range in which the obstacle is recognized for the driving assistance is narrowed when it is determined that the road division line indicates a curved road.

(2): In an aspect of the above (1), the processor performs correction so that a width of the determination region is decreased when it is determined that the road division line indicates a curved road.

(3): In an aspect of the above (2), the processor performs correction so that a length of the determination region is decreased when it is determined that the road division line indicates a curved road.

(4): In an aspect of the above (1), the processor determines that the recognized road division line indicates a curved road when a length of the recognized road division line is shortened by a predetermined amount or more.

(5): In an aspect of the above (1), the processor determines that the recognized road division line indicates a curved road when a period in which a length of the recognized road division line is shortened by a predetermined amount or more has elapsed by a predetermined time or more.

(6): In an aspect of the above (1), the processor decreases a speed of the vehicle when a collision margin time between the vehicle and the recognized obstacle is a threshold value or less.

(7): A driving assistance method according to another aspect of the present invention causing a computer to: recognize a road division line of a traffic lane in which a vehicle is traveling and an obstacle which exists around the vehicle using at least one of a camera and a radar installed in the vehicle, determine whether the road division line indicates a curved road on the basis of a length of the recognized road division line, perform a driving assistance for the vehicle in accordance with the recognized obstacle, and perform correction so that a determination region that is a range in which the obstacle is recognized for the driving assistance is narrowed when it is determined that the road division line indicates a curved road.

(8): A computer-readable non-transient storage medium according to another aspect of the present invention which stores a program causing a computer to: recognize a road division line of a traffic lane in which a vehicle is traveling and an obstacle which exists around the vehicle using at least one of a camera and a radar installed in the vehicle, determine whether the road division line indicates a curved road on the basis of a length of the recognized road division line, perform a driving assistance for the vehicle in accordance with the recognized obstacle, and perform correction so that a determination region that is a range in which the obstacle is recognized for the driving assistance is narrowed when it is determined that the road division line indicates a curved road.

According to (1) to (8), it is possible to provide a driving assistance device, a driving assistance method, a storage medium which are capable of detecting the presence of a curved road which exists in the distance and appropriately suppressing a driving assistance in accordance with the detected curved road.

### BRIEF DESCRIPTION OF THE DRAWINGS

FIG. 1 is a diagram showing an example of a constitution of a driving assistance device installed in a subject vehicle M.

FIG. 2 is a diagram for explaining an overview of a driving assistance performed using a driving assistance part.

FIG. 3 is a diagram for explaining an excessive operation of CMBS.

FIG. 4 is a diagram showing a method of determining a curved road using a determination part.

FIG. 5 is a diagram for explaining an example of a method of changing a determination region using a driving assistance part 130 when it is determined that a road division line indicates a curved road.

FIG. 6 is a diagram for explaining another example of the method of changing a determination region using the driving assistance part 130 when it is determined that the road division line indicates a curved road.

FIG. 7 is a flowchart for describing an example of a flow of a process performed using a driving assistance device.

FIG. 8 is a flowchart for describing another example of the flow of the process performed using the driving assistance device.

FIG. 9 is a flowchart for describing another example of the flow of the process performed using the driving assistance device.

### DESCRIPTION OF EMBODIMENTS

Embodiments of a driving assistance device, a driving assistance method, and a storage medium of the present invention will be described below with reference to the drawings.

### [Constitution]

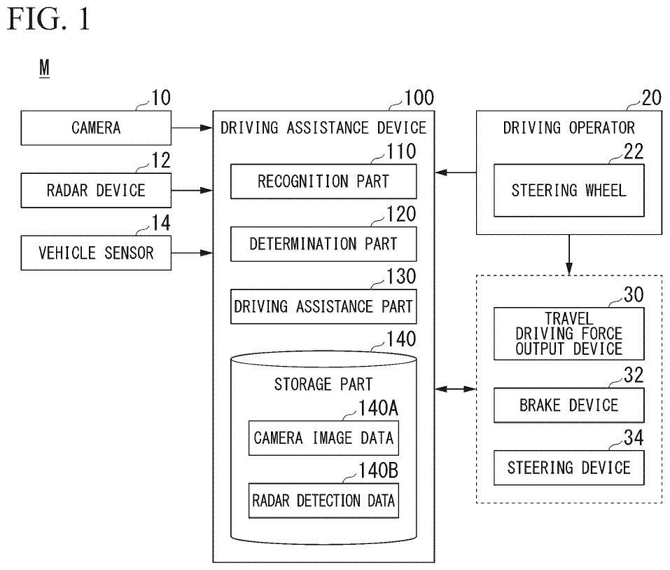

FIG. 1 is a diagram showing an example of a constitution of a driving assistance device 100 installed in a subject vehicle M. The subject vehicle M includes, for example, a camera 10, a radar device 12, a vehicle sensor 14, a driving operator 20, a steering wheel 22, a travel driving force output device 30, a brake device 32, a steering device 34, and a driving assistance device 100.

The camera 10 is a digital camera which uses a solid-state image sensor such as a charge coupled device (CCD) or a complementary metal oxide semiconductor (CMOS). The camera 10 is attached to any location of a vehicle (hereinafter referred to as a “subject vehicle M”) having the driving assistance device 100 installed therein. When capturing an image of the front, the camera 10 is attached to an upper portion of a front windshield, a rear surface of a room mirror, or the like. The camera 10, for example, periodically and repeatedly captures images of the surroundings of the subject vehicle M. The camera 10 may be a stereo camera. The camera 10 transmits the captured image to the driving assistance device 100 and the driving assistance device 100 stores the received image in a storage part 140 as camera image data 140A.

The radar device 12 emits radio waves such as millimeter waves around the subject vehicle M and detects the radio waves reflected by an object (reflected waves) to detect at least a position (distance and bearing) of the object. The radar device 12 is attached to any place of the subject vehicle M. The radar device 12 may detect a position and a speed of an object through a Frequency Modulated Continuous Wave (FM-CW) method. The radar device 12 transmits the detection result to the driving assistance device 100 and the driving assistance device 100 stores the detection result in the storage part 140 as radar detection data 140B.

The vehicle sensor 14 includes a vehicle speed sensor which detects a speed of the subject vehicle M, an acceleration sensor which detects an acceleration, a yaw rate sensor which detects an angular velocity around a vertical axis, a bearing sensor which detects a direction of the subject vehicle M, and the like.

The driving operator 20 includes, for example, the steering wheel 22 as well as an accelerator pedal, a brake pedal, a shift lever, and other operators. The driving operator 20 has a sensor which detects an amount of operation or the presence or absence of operation attached thereto and the detection result is output to the driving assistance device 100 or a part or all of the travel driving force output device 30, the brake device 32, and the steering device 34. The operator does not necessarily need to have an annular shape and may be a steering having a different shape or have a form of a joystick, a button, or the like.

The travel driving force output device 30 outputs a travel driving force (torque) for traveling of the subject vehicle M to driving wheels. The travel driving force output device 30 includes, for example, a combination of an internal combustion engine, an electric motor, a transmission, and an Electronic Control Unit (ECU) which controls these. The ECU controls the above constitution in accordance with information input from the driving assistance device 100 or information input from the driving operator 20.

The brake device 32 includes, for example, a brake caliper, a cylinder which transmits hydraulic pressure to the brake caliper, an electric motor which generates hydraulic pressure in the cylinder, and a brake ECU. The brake ECU controls the electric motor in accordance with information input from the driving assistance device 100 or information input from the driving operator 20 so that a brake torque according to the braking operation is output to each of the wheels. The brake device 32 may include, as a backup, a mechanism which transmits hydraulic pressure generated through an operation of the brake pedal included in the driving operator 20 to the cylinder via a master cylinder. The brake device 32 is not limited to the constitution described above and may be an electronically controlled hydraulic pressure brake device which controls an actuator in accordance with information input from the driving assistance device 100 to transmit the hydraulic pressure of the master cylinder to the cylinder.

The steering device 34 includes, for example, a steering ECU and an electric motor. The electric motor, for example, applies a force to a rack and pinion mechanism to change the direction of the steered wheels. The steering ECU drives the electric motor in accordance with information input from the driving assistance device 100 or information input from the driving operator 20 to change the direction of the steered wheels.

The driving assistance device 100 includes, for example, a recognition part 110, a determination part 120, a driving assistance part 130, and the storage part 140. The recognition part 110, the determination part 120, and the driving assistance part 130 are realized by, for example, a hardware processor such as a Central Processing Unit (CPU) executing a program (software). Some or all of these constituent elements may be realized using hardware (circuit part; including a circuitry) such as a Large Scale Integration (LSI), an Application Specific Integrated Circuit (ASIC), a Field-Programmable Gate Array (FPGA), a Graphics Processing Unit (GPU), or a System On Chip (SOC) or may be realized by a combination of software and hardware. The program may be stored in advance in a storage device (storage device including a non-transient storage medium) such as a hard disk drive (HDD) or flash memory or may be stored on a removable storage medium (non-transient storage medium) such as a DVD or CD-ROM and installed by inserting the storage medium into the drive device. The storage part 140 is, for example, a HDD, a flash memory, a Random Access Memory (RAM), or the like. The storage part 140 stores, for example, camera image data 140A and radar detection data 140B.

The recognition part 110 performs sensor fusion processing on the detection result based on a part or all of the camera image data 140A and the radar detection data 140B and recognizes a position, a type, a speed, and the like of the object. For example, the recognition part 110 performs image processing on the camera image data 140A to recognize pedestrians, other vehicles, road structures (road division lines, walls, and the like), and the like which are captured in the camera image. Furthermore, the recognition part 110 recognizes pedestrians, other vehicles, road structures (walls and the like), and the like which exist around the subject vehicle M on the basis of the radar detection data 140B.

The determination part 120 determines whether the recognized road division line indicates a curved road on the basis of the length of the recognized road division line. The determination process performed using the determination part 120 will be described in detail later.

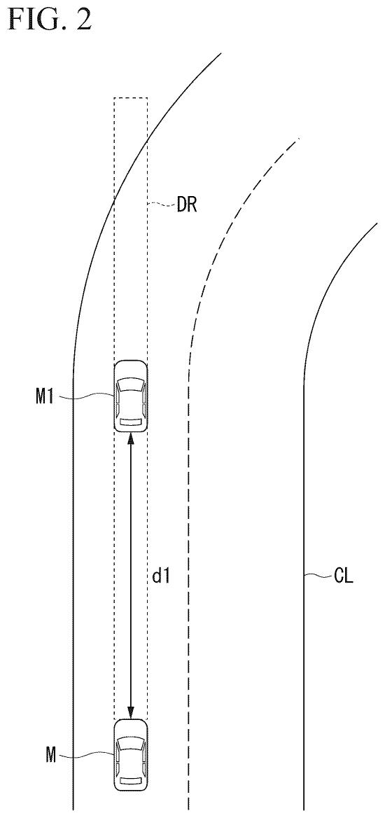

The driving assistance part 130 performs a driving assistance for the subject vehicle M in accordance with an obstacle recognized using the recognition part 110. FIG. 2 is a diagram for explaining an overview of the driving assistance performed using the driving assistance part 130. In FIG. 2, symbol CL represents a road division line recognized on the basis of the camera image data 140A, symbol M1 represents another vehicle, and a region enclosed by symbol DR represents a determination region in which an obstacle that is an execution target of driving assistance is recognized. In FIG. 2, as an example, although a case in which a width of the determination region is the same as a width of the subject vehicle M is shown, the present invention is not limited to such a constitution and they may differ.

The driving assistance part 130 performs a driving assistance for the subject vehicle M on the basis of the recognition results using the recognition part 110. In the embodiment, it is assumed that the “driving assistance” refers to a collision mitigation brake (Collision Mitigation Brake System: CMBS) which automatically operates the brake device 32 so that the subject vehicle M avoids a collision with an obstacle (in other words, an obstacle which exists in the determination region DR) which exists in a direction in which the subject vehicle M moves forward or so that a collision speed is reduced. More specifically, the driving assistance part 130 determines whether there are obstacles such as pedestrians or other vehicles in the determination region DR on the basis of the recognition result using the recognition part 110. In addition, when it is determined that an obstacle exists in the determination region DR, the driving assistance part 130 calculates a collision margin time (Time To Collision: TTC) that is a time until the subject vehicle M collides with the object on the basis of information acquired from the recognition part 110 and the vehicle sensor 14 (for example, a relative distance to and a relative speed of an object).

For example, in the case of FIG. 2, the driving assistance part 130 performs calculation through TTC=d1/v on the basis of a distance d1 between the subject vehicle M and another vehicle M1 and a relative speed v of the subject vehicle M relative to the other vehicle M1. If the driving assistance part 130 calculates TTC, then a determination concerning whether the calculated TTC is a threshold value or less is performed. When the calculated TTC is the threshold value or less, the driving assistance part 130 operates the CMBS for the subject vehicle M.

### [Suppression of Driving Assistance]

In this way, the driving assistance part 130 calculates the TTC of the subject vehicle M with respect to the obstacles which exist in the determination region DR and operates the CMBS for the subject vehicle M when the calculated TTC is the threshold value or less. Here, for example, the radar device 12 can detect obstacles at relatively long distances. Thus, with the technique in the related art, by rights, there are cases in which obstacles which need not have been covered by driving assistance are detected, resulting in an excessive operation of the CMBS.

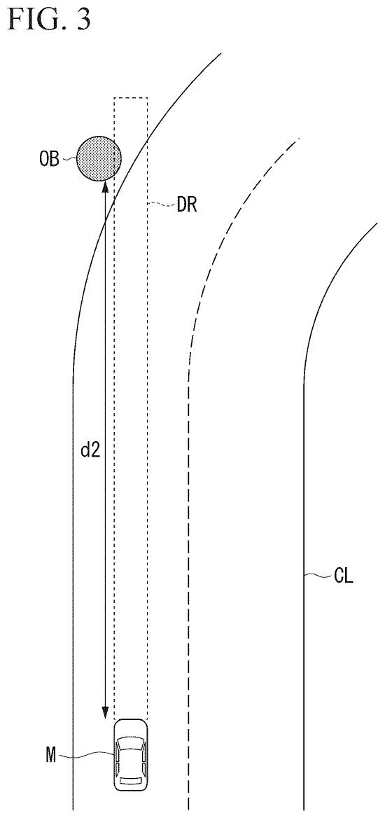

FIG. 3 is a diagram for explaining an excessive operation of the CMBS. In FIG. 3, symbol OB represents an obstacle located outside the curved road. The driving assistance part according to the technique in the related art sometimes unnecessarily operates the CMBS for obstacles OB located outside the curved road, even though these obstacles need not have been subjected to a CMBS operation by rights. As a result, a braking force may be applied to the subject vehicle M at an unnecessary timing, causing discomfort to the occupants of the subject vehicle M.

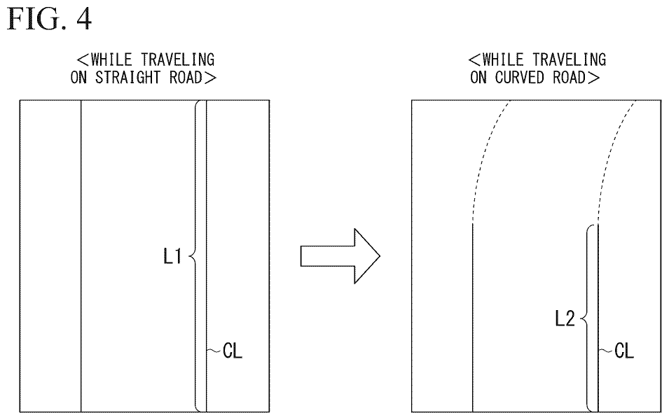

In light of the circumstances as described, the determination part 120 first determines whether the recognized road division line indicates a curved road on the basis of the length of the recognized road division line (detection distance). FIG. 4 is a diagram showing an example of a method of determining a curved road using the determination part 120. FIG. 4 is a diagram obtained by, for example, converting a road division line captured in the camera image data 140A from a camera coordinate system to a bird's-eye view coordinate system. The left part of FIG. 4 shows a road division line CL recognized while the subject vehicle M is traveling on a straight road and the right part of FIG. 4 shows a road division line CL recognized while the subject vehicle Mis traveling on a curved road.

As shown in FIG. 4, generally, a length L1 of the road division line CL recognized when the subject vehicle M is traveling on a straight road tends to be longer than a length L2 of the road division line CL recognized when the subject vehicle M approaches a curved road. This is because, as the subject vehicle M approaches the curved road, the road division line CL is in a blind spot and the recognized length of the road division line CL decreases. For this reason, the determination part 120 calculates the length of the recognized road division line CL during a predetermined control cycle while the subject vehicle Mis traveling. In addition, when the calculated length of the road division line CL is shorter than the previous length by a predetermined amount or more, it is determined that the recognized road division line CL indicates a curved road. Furthermore, for example, when a period in which the calculated length of the road division line CL is shorter than the previous length by a predetermined amount or more has elapsed by a predetermined time or more, the determination part 120 may determine that the recognized road division line CL indicates a curved road. Thus, it is possible to accurately detect a curved road located far away from subject vehicle M.

In yet another embodiment, the determination part 120 may calculate the length of a recognized road division line CL during a predetermined control cycle while the subject vehicle M is traveling, calculate a moving average distance of a length of the road division line CL for the most recent predetermined period (or predetermined number of times), and determine whether a length of the current road division line CL has become shorter than the calculated moving average distance by a predetermined amount or more. Furthermore, for example, when a period in which the length of the current road division line CL is shorter than the calculated moving average distance by a predetermined amount or more has elapsed by a predetermined time or more, the determination part 120 may determine that the recognized current road division line CL indicates a curved road. Thus, curved roads located far away from subject vehicle M can be detected with even greater accuracy.

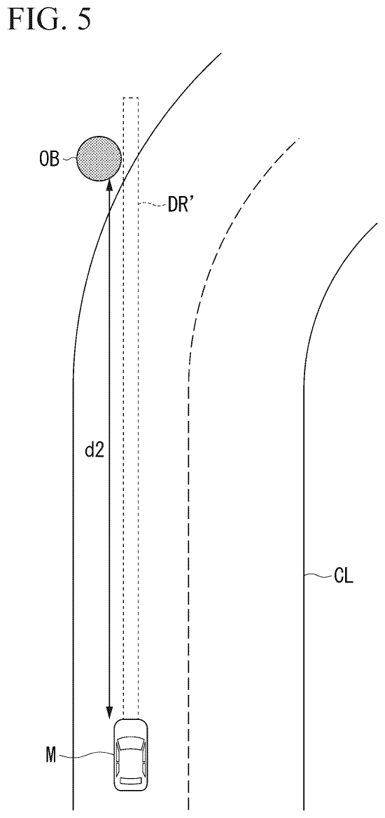

FIG. 5 is a diagram for explaining a change in the determination region using the driving assistance part 130 when it is determined that the road division line indicates a curved road. As shown in FIG. 5, when it is determined by the determination part 120 that the road division line indicates a curved road, the driving assistance part 130 performs correction so that a width of the determination region DR is narrowed, thereby obtaining a corrected determination region DR′. Thus, as shown in FIG. 5, the recognition part 110 does not recognize an obstacle OB located outside the curved road in the corrected determination region DR′ and the driving assistance part 130 can suppress an operation of the CMBS for the obstacle OB. Furthermore, even if the obstacle OB temporarily enters the determination region DR′, an excessive operation of the CMBS can be suppressed.

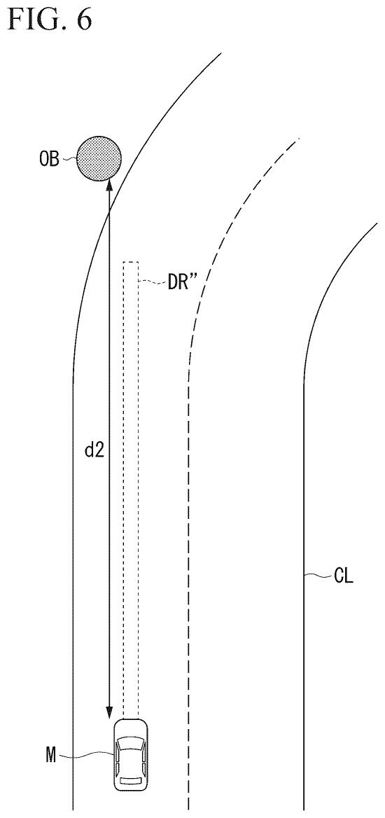

FIG. 6 is a diagram for explaining another example of the method of changing a determination region using the driving assistance part 130 when it is determined that the road division line indicates a curved road. As shown in FIG. 6, when it is determined by the determination part 120 that the road division line indicates a curved road, the driving assistance part 130 may obtain a corrected determination region DR″ by decreasing the length of the determination region DR. Thus, as shown in FIG. 6, the driving assistance part 130 can suppress an unnecessary operation of the CMBS for an obstacle OB positioned outside the curved road.

In FIGS. 5 and 6, as an example, although the driving assistance part 130 corrects the width and the length of the determination region DR separately, the present invention is not limited to such a constitution and the driving assistance part 130 may correct the width and the length of the determination region DR together. Furthermore, more generally, the driving assistance part 130 may perform a correction so that at least an area of the determination region DR is reduced. Even in this way, the driving assistance part 130 can prevent the CMBS from being operated in response to the recognition of an obstacle which does not require an operation of the CMBS.

In addition, in the above description, as an example, a case in which the obstacle OB is located outside the curved road has been described. Here, the present invention is not limited to such a constitution, and even if an obstacle OB is located inside a curved road, the driving assistance part 130 can prevent the operation of the CMBS on an obstacle OB for which an operation of the CMBS is not required in accordance with the above control.

### [Flow of Control]

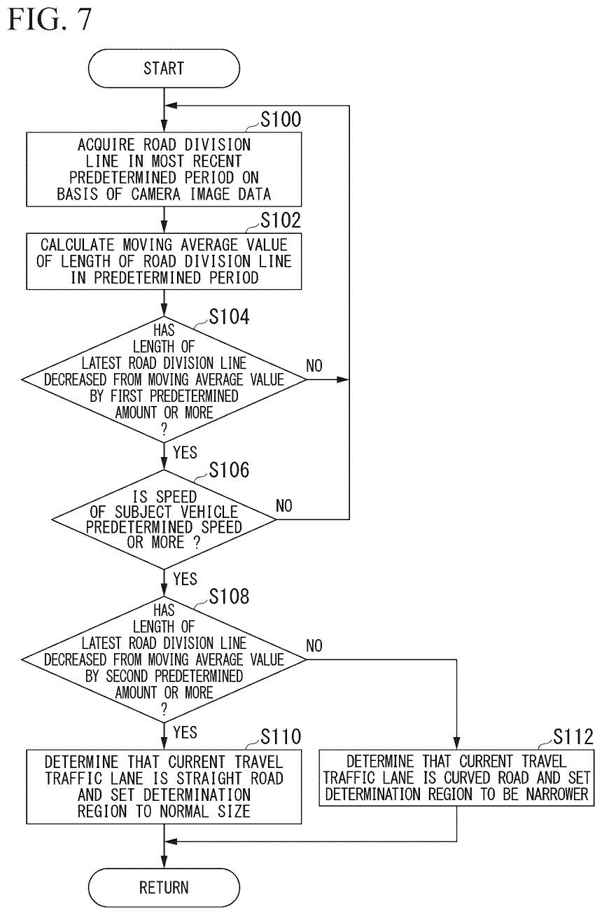

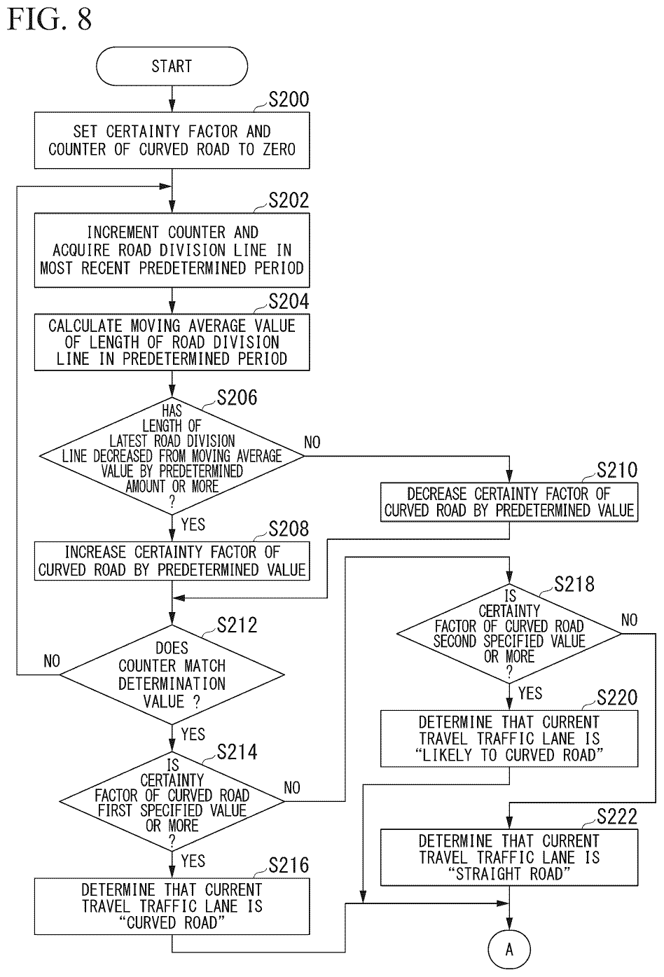

A flow of a process performed using the driving assistance device 100 will be described below with reference to FIGS. 7 and 8. FIG. 7 is a flowchart for describing an example of the flow of the process performed using the driving assistance device 100. The process of the flowchart shown in FIG. 7 is repeatedly performed in predetermined control cycles while the subject vehicle M is traveling.

First, the recognition part 110 acquires a road division line in the most recent predetermined period on the basis of the camera image data 140A (Step S100). Subsequently, the determination part 120 calculates a moving average value of a length of the road division line in a predetermined period (Step S102). Subsequently, the determination part 120 determines whether the length of the latest road division line has decreased from the moving average value by a first predetermined amount or more (Step S104). Here, the first predetermined amount is a value smaller than the second predetermined amount which will be described below and is used for making a preliminary determination.

If it is determined that the length of the latest road division line has not decreased from the moving average value by the first predetermined amount or more, the determination part 120 returns the process to Step S100. On the other hand, when it is determined that the length of the latest road division line has decreased from the moving average value by the first predetermined amount or more, the determination part 120 then determines whether a speed of the subject vehicle M is a predetermined speed or more (Step S106). When it is determined that the speed of the subject vehicle M is less than a predetermined speed, the determination part 120 returns the process to Step S100. This is because, when the speed of the subject vehicle M is less than the predetermined speed, there is little need to operate the CMBS in the first place.

When it is determined that the speed of the subject vehicle M is the predetermined speed or more, the determination part 120 then determines whether the length of the latest road division line has decreased from the moving average value by a second predetermined amount or more (Step S108). When it is not determined that the length of the latest road division line has not decreased from the moving average value by the second predetermined amount or more, the driving assistance part 130 determines that the current travel traffic lane is a straight road and sets the determination region DR to a normal size (Step S110). On the other hand, when it is determined that the length of the latest road division line has decreased from the moving average value by the second predetermined amount or more, the driving assistance part 130 sets the determination region DR to be narrower (Step S112). Thus, the process of this flowchart ends.

In the flowchart of FIG. 7, in Step S106, although it is determined whether the speed of the subject vehicle M is a predetermined speed or more, this process may be omitted. Also, in Step S108, although a determination concerning whether the current travel traffic lane is a straight road or a curved road is determined based on whether the length of the latest road division line has decreased from the moving average value by the second predetermined amount or more, a plurality of threshold values may be set to make a more detailed determination. For example, the driving assistance part 130 may determine that there is a high likelihood of a straight road (high probability of a straight road) when the length of the latest road division line has decreased by the first threshold value or less from the moving average value, there is a likelihood of a straight road (low likelihood of a straight road) when the length of the latest road division line is more than the first threshold value or less and has decreased by the second threshold value or less, there is a likelihood of a curved road (low likelihood of a curved road) when the length of the latest road division line is more than the second threshold value and has decreased by a third threshold value or less, and there is a high likelihood of a curved road (high likelihood of a curved road) when the length of the latest road division line has decreased more than the third threshold value. In this case, the driving assistance part 130 may set an area (at least one of a width and a length) of the determination region DR to be gradually smaller in accordance with the “high likelihood of a straight road,” the “low likelihood of a straight road,” the “low likelihood of a curved road,” and the “high likelihood of a curved road.”

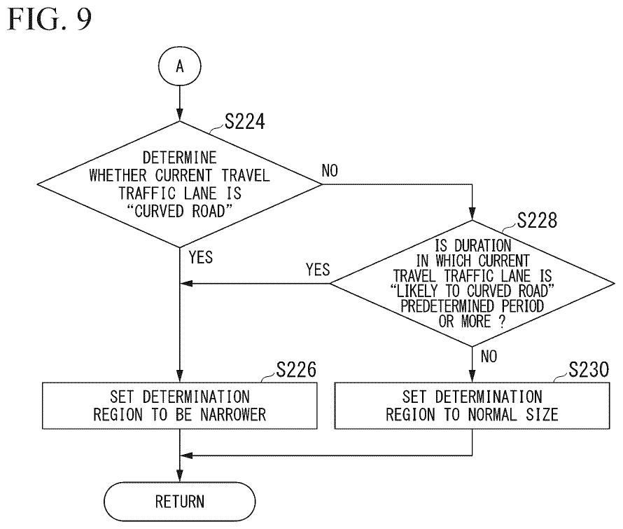

FIGS. 8 and 9 are flowcharts for describing another example of a flow of a process performed using the driving assistance device 100. As in FIG. 7, the processes of the flowcharts shown in FIGS. 8 and 9 are performed repeatedly in a predetermined control cycle while the subject vehicle Mis traveling. In addition, unlike FIG. 7, it more accurately determines whether a road is a curved road by utilizing a certainty factor of the curved road.

First, the determination part 120 sets a certainty factor and a counter of a curved road to zero (Step S200). Subsequently, the recognition part 110 increments the counter and acquires the road division line in the most recent predetermined period on the basis of the camera image data 140A (Step S202). Subsequently, the determination part 120 calculates a moving average value of a length of the road division line in the predetermined period (Step S204). Subsequently, the determination part 120 determines whether the length of the latest road division line has decreased from the moving average value by a predetermined amount or more (Step S206).

When it is determined that the length of the latest road division line has decreased from the moving average value by the predetermined amount or more, the determination part 120 increases the certainty factor of the curved road by a predetermined value (Step S208). On the other hand, when it is determined that the length of the latest road division line has not decreased by the predetermined amount or more from the moving average value, the determination part 120 decreases the certainty factor of the curved road by the predetermined value (Step S210). Subsequently, the determination part 120 determines whether the counter matches the determination value (Step S212). When it is determined that the counter does not match the determination value, the determination part 120 returns the process to Step S202. That is to say, the processes from Step S202 to Step S212 cumulatively increase or decrease the certainty factor of a curved road, thereby more accurately determining whether the current travel traffic lane is a curved road.

When it is determined that the counter matches the determination value, the determination part 120 determines whether the certainty factor of the curved road is a first specified value or more (Step S214). When it is determined that the certainty factor of a curved road is the first specified value or more, the determination part 120 determines that the current travel traffic lane is a “curved road” (Step S216). On the other hand, when it is determined that the certainty factor of the curved road is less than the first specified value, the determination part 120 determines whether the certainty factor of the curved road is a second specified value or more (Step S218). When it is determined that the certainty factor of the curved road is the second specified value or more, the determination part 120 determines that the current travel traffic lane is “likely to a curved road” (Step S220). On the other hand, when it is determined that the certainty factor of the curved road is less than the second specified value, the determination part 120 determines that the current travel traffic lane is a “straight road” (Step S222).

Transitioning to the flowchart of FIG. 9, the driving assistance part 130 determines whether the current travel traffic lane is determined to be a “curved road” (Step S224). When it is determined that the current travel traffic lane is a “curved road,” the driving assistance part 130 sets the determination region to be narrower (Step S226). On the other hand, when it is not determined that the current travel traffic lane is a “curved road,” the driving assistance part 130 determines whether a duration in which the current travel traffic lane is “likely to a curved road” is a predetermined period or more (Step S228). When it is determined that the duration in which the current travel traffic lane is “likely to a curved road” is the predetermined period or more, the driving assistance part 130 sets the determination region to be narrower in Step S226. On the other hand, when it is determined that the duration in which the current travel traffic lane is “likely to a curved road” is not the predetermined period or more, the driving assistance part 130 sets the determination region to a normal size (Step S230). Thus, the process of this flowchart ends.

According to the embodiment provided as described above, the determination part determines whether the road division line indicates a curved road on the basis of the length of the recognized road division line. In addition, when it is determined that the road division line indicates a curved road, the driving assistance part performs correction so that the determination region that is a range in which an obstacle is recognized for a driving assistance is narrowed. Thus, it is possible to detect the presence of a curved road in the distance and to appropriately suppress a driving assistance in accordance with the detected curved road. In addition, the present invention contributes to the development of an accessible transport system.

The above-described embodiment can be expressed as follows.

A driving assistance device includes
a storage medium which has computer-readable instructions stored therein, and
a processor which is connected to the storage medium,
in which the processor is constituted to execute the computer-readable instructions to:
recognize a road division line of a traffic lane in which the vehicle is traveling and an obstacle which exists around the vehicle using at least one of a camera and a radar installed in a vehicle,
determine whether the road division line indicates a curved road on the basis of a length of the recognized road division line,
perform a driving assistance for the vehicle in accordance with the recognized obstacle, and
set a determination region in which the obstacle is recognized to be narrower when it is determined that the road division line indicates a curved road.

Although aspects for carrying out the present invention has been explained above using the embodiments, the present invention is not limited to these embodiments in any way and various modifications and substitutions can be provided without departing from the gist of the present invention.

What is claimed is:

1. A driving assistance device, comprising:
a storage medium which has computer-readable instructions stored therein, and
a processor which is connected to the storage medium,
wherein the processor is constituted to execute the computer-readable instructions to:
recognize a road division line of a traffic lane in which the vehicle is traveling and an obstacle which exists around the vehicle using at least one of a camera and a radar installed in a vehicle,
determine whether the road division line indicates a curved road on the basis of a length of the recognized road division line, and
perform a driving assistance for the vehicle in accordance with the recognized obstacle, and
the processor performs correction so that a determination region that is a region in which the obstacle is recognized for the driving assistance is narrowed when it is determined that the road division line indicates a curved road.

2. The driving assistance device according to claim 1, wherein the processor performs correction so that a width of the determination region is decreased when it is determined that the road division line indicates a curved road.

3. The driving assistance device according to claim 2, wherein the processor performs correction so that a length of the determination region is decreased when it is determined that the road division line indicates a curved road.

4. The driving assistance device according to claim 1, wherein the processor determines that the recognized road division line indicates a curved road when a length of the recognized road division line is shortened by a predetermined amount or more.

5. The driving assistance device according to claim 1, wherein the processor determines that the recognized road division line indicates a curved road when a period in which a length of the recognized road division line is shortened by a predetermined amount or more has elapsed by a predetermined time or more.

6. The driving assistance device according to claim 1, wherein the processor decreases a speed of the vehicle when a collision margin time between the vehicle and the recognized obstacle is a threshold value or less.

7. A driving assistance method causing a computer to:
recognize a road division line of a traffic lane in which a vehicle is traveling and an obstacle which exists around the vehicle using at least one of a camera and a radar installed in the vehicle,
determine whether the road division line indicates a curved road on the basis of a length of the recognized road division line,
perform a driving assistance for the vehicle in accordance with the recognized obstacle, and
perform correction so that a determination region that is a range in which the obstacle is recognized for the driving assistance is narrowed when it is determined that the road division line indicates a curved road.

8. A computer-readable non-transient storage medium which stores a program causing a computer to:
recognize a road division line of a traffic lane in which a vehicle is traveling and an obstacle which exists around the vehicle using at least one of a camera and a radar installed in the vehicle,
determine whether the road division line indicates a curved road on the basis of a length of the recognized road division line,
perform a driving assistance for the vehicle in accordance with the recognized obstacle, and
perform correction so that a determination region that is a range in which the obstacle is recognized for the driving assistance is narrowed when it is determined that the road division line indicates a curved road.
